(19) United States
(12) Patent Application Publication
(10) Pub. No.: US 2011/0218716 A1
(43) Pub. Date: Sep. 8, 2011

(54) PRE-SELECTION OF GEAR FOR A DOUBLE-CLUTCH TRANSMISSION

(75) Inventors: Petra Olsson, Ljungskile (SE); Lennart Olausson, Goteburg (SE); Tobias Berndtson, Graestorp (SE)

(73) Assignee: GM GLOBAL TECHNOLOGY OPERATIONS LLC, Detroit, MI (US)

(21) Appl. No.: 13/041,598

(22) Filed: Mar. 7, 2011

(30) Foreign Application Priority Data
Mar. 5, 2010 (GB) 1003675.4

(51) Int. Cl. F16H 59/38; F16H 3/093

(52) U.S. Cl. 701/51; 74/665 A

(57) ABSTRACT

A method is provided for preselecting gear in a double-clutch transmission that includes, but is not limited to measuring at least two types of transmission speed of the double-clutch transmission, evaluating the at least two types of transmission speed, determining a next gear of the double-clutch transmission and preselecting the next gear.

### CROSS-REFERENCE TO RELATED APPLICATION

This application claims priority to British Patent Application No. 1003675.4, filed Mar. 5, 2010, which is incorporated herein by reference in its entirety.

### TECHNICAL FIELD

The technical field relates to a double clutch transmission for pre-selection of gear. It also relates to a method of preselecting gear for the double-clutch transmission.

### BACKGROUND

A double-clutch transmission comprises two input shafts that are connected to and actuated by two clutches separately. The two clutches are often enclosed by a housing to form a single device. The two clutches are connected to the two input shafts separately for transmitting driving torque from an engine to any of the two input shafts at a time. Typical double clutch transmissions suffer from poor fuel efficiency although many fuel-saving techniques have been adopted. Both car manufacturers and motorists require new techniques to further improve the fuel efficiency at low cost.

### SUMMARY

The present application provides a method for preselecting gear in a double-clutch transmission. The method comprises a step of measuring two or more types of transmission speed of the double-clutch transmission. The types of transmission speed includes an input speed of the double-clutch transmission, an output speed of the double-clutch transmission, a change of speed at one or more input shafts of the double-clutch transmission and a change of speed at one or more output shaft of the double-clutch transmission. The transmission speed further includes various speeds of gearwheels and shafts of the double-clutch transmission.

Usually, measuring a speed or an acceleration of a vehicle that is installed with the double-clutch transmission is equivalent to measuring the output speed of the double-clutch transmission and the acceleration at the output of the double-clutch transmission respectively. The method also comprises a step of evaluating the two or more transmission speeds. The step of evaluating comprises comparing the transmission speed against predetermined thresholds. The step of evaluating also comprises a step of comparing multiple transmission speeds for judging whether the transmission speed increases or decreases over time. The step of evaluating further comprises a step of comparing multiple transmission speeds for calculating rates of the increase or decrease.

The method further comprises a step of determining a next gear of the double-clutch transmission. The next gear is based on evaluating the transmission speed so that predictions of the next-to-engage gear are put forward. Scheme of predictions can be programmed on in a transmission control unit for selecting gear. Additionally, the method comprises a step of preselecting the next gear. The step of preselecting comprises engaging components of the next gear train. For example, the preselecting comprises locking an idler of the next gear to its weight-carrying layshaft. Preselected idler does not receive driving torque from an engine because a clutch disc of the next gear is not yet connected to the engine. The act of pre-selection reduces the number of engaging components so that there is less number of couplings and loss of momentum when the next gear is selected for driving.

The method that causes the pre-selection of next gear based on two more types of transmission speed, which is more accurate and reliable for gear pre-selection. For example, the double-clutch transmission causes the pre-selecting a higher gear when both an input speed and an output speed of the transmission increases, which provides more reliable prediction for the next gear. The pre-selection of the higher gear can be wrong if the pre-selection depends on the input speed alone. This is because the increase of input speed may be due to a driver's stepping on an acceleration pedal of the transmission when driving uphill, but the driver actually intends driver slower.

The two or more types of transmission speed can comprise an input speed of the double-clutch transmission, or an acceleration speed at an output of the transmission. The two or more types of transmission speed can also comprise an output speed of the transmission, or an acceleration speed at an input of the transmission.

The step of evaluating can comprise a step of gauging or quantifying a change of the transmission speeds of the double-clutch transmission. The transmission speeds can be picked up one or more sensors that send electrical signals to the transmission control unit via cables. The transmission control unit processes the electrical signals so that the transmission control unit detects speeds or toques of an input, an output or other parts of the double-clutch transmission. Together with inputs from an engine control unit, the transmission control unit regulates the parts of the double-clutch transmission. The change of the transmission speeds may be known as acceleration or deceleration, although the deceleration is another form of acceleration in a negative direction.

The step of measuring can comprise a step of sensing a speed change of a vehicle that is installed with the double-clutch transmission. The step of measuring can be implemented by attaching sensors to moving parts of the double-clutch transmission or on a frame of the vehicle. The speed change of the vehicle, which is acceleration, is detected by sensors for observing movements of the vehicle. Speed sensors can be readily adopted for checking the speed change of the vehicle at low cost.

The step of measuring can comprise a step of detecting an input speed of the double-clutch transmission. The double-clutch transmission receives the input speed at its two input shafts that are connected to an engine via a double clutch. The input speed reflects an output speed of the engine. Since the output speed of the engine is directly controlled by a driver of the vehicle, the detection of the input speed of the double-clutch transmission gives clear indication on whether the driver intends to speed up or slow down, thus provide reliable indication for controlling the double-clutch transmission.

The step of determining can comprise a step of predicting a higher gear if the double-clutch transmission accelerates or predicting a lower gear if the double-clutch transmission decelerates. Once the input speed of the double-clutch transmission increases, there is an indication that the driver wants to accelerate. Similarly, there is an indication that the driver wishes to decelerate if the input speed of the double-clutch transmission decreases. Accordingly, gear can be appropriately selected for moving the vehicle at suitable speed and efficiency.

The step of determining can further comprise a step of predicting a higher gear if the engine accelerates, or predicting a lower gear if the engine decelerates. The technique of predicting next gear can be programmed into the transmission control unit. Once the transmission control unit or the engine control unit senses that the engine increases its speed, the transmission control unit or the engine control unit predicts that the next gear is a higher gear. A lower gear is predicted if the transmission control unit or the engine control unit senses that the engine decreases its speed. The engine speed is regulated by an acceleration pedal, which is directly controlled by the driver.

The step of determining can further comprise a step of predicting a higher gear if the input speed of the double-clutch transmission exceeds a speed threshold or predicting a lower gear if the input speed of the double-clutch transmission is lower than the speed threshold. Since the double-clutch transmission receives a stable input speed and the driving torque from the engine, fluctuations of the input speed and the driving torque are linked to the driver's intensions for speeding. Once the input speed of the double-clutch transmission drops below a threshold or goes beyond a set value, the transmission control unit predict indications of acceleration or deceleration accordingly, in response to the driver's actions.

The step of determining further comprises a step of predicting a higher gear if both the double-clutch transmission accelerates and the input speed of the double-clutch transmission increases. Once both an input speed of the double-clutch transmission and the vehicle's speed increase, the transmission control unit has a higher confidence level of predicting a higher gear for the next. This avoids an error of predicting a next gear to be higher where the vehicle increases its speed, but the engine speed is still low. Such situation happens when the vehicle moves down a slope with an increase in speed, but the engine speed is still low. Therefore, the arrangement of predicting a next gear depending on both the acceleration of the double-clutch transmission and the input speed of the engine gives the prediction of a next gear with more accuracy.

The step of determining further can comprise a step of predicting a lower gear if both the double-clutch transmission decelerates and the input speed of the double-clutch transmission decreases. When the vehicle drives up a hill, the double-clutch transmission reduces its output speed, but the engine speed is still rather high. The prediction of the next gear to be higher will be wrong if the transmission control unit only takes the input speed of the double-clutch transmission 1 into account. Watching both the deceleration of the double-clutch transmission at its output end and output end provides more reliable and accurate prediction of the next gear.

The present application provides a powertrain for preselecting gear. The powertrain comprises a speed sensor mounted on the powertrain, a transmission control unit that is connected to the speed sensor and a double-clutch transmission that is controlled by the transmission control unit.

The double-clutch transmission further comprises an inner input shaft and an outer input shaft. The outer input shaft encloses a portion of the inner input shaft. An inner clutch disc is connected to the inner input shaft whilst an outer clutch disc is connected to the outer input shaft. The inner clutch disc and the outer clutch disc are parts of a double clutch that has a clutch housing for enclosing the two clutch discs. The double-clutch transmission also comprises a first layshaft and a second layshaft that are spaced apart from each other in parallel to the input shafts. A pinion of the double-clutch transmission is mounted on one of the layshafts for outputting drive torque.

Gearwheels of the double-clutch transmission are arranged on the first layshaft, on the second layshaft, on the inner input shaft and on the outer input shaft. The gearwheels comprises a first gearwheel train, a second gearwheel train, a third gearwheel train, a fourth gearwheel train and a fifth gearwheel train for providing five sequentially increasing forward gears respectively.

The first gearwheel train comprises a gearwheel first gear on one of the input shafts, meshing with an idler first gear on one of the layshafts. The third gearwheel train comprises a gearwheel third gear on one of the input shafts, meshing with an idler third gear on one of the layshafts. The fifth gearwheel train comprises a gearwheel fifth gear on one of the input shafts, meshing with an idler fifth gear on one of the layshafts. The second gearwheel train comprises a gearwheel second gear on the other input shaft, meshing with an idler second gear on the other layshaft. The fourth gearwheel group comprises a gearwheel fourth gear on the other input shaft, meshing with an idler fourth gear on the other layshaft. Each gearwheel train comprises one or more coupling devices on one of the layshafts to selectively engage one of the idler gearwheels for providing one of the five gears.

The double-clutch transmission further comprises an output gearwheel on an output shaft for meshing with the pinion. The transmission control unit is configured to control the double-clutch transmission for preselecting a next gear depending on two or more types of transmission speed of the double-clutch transmission. In the double-clutch transmission, an idler gearwheel and a coupling device can replace a fixed gearwheel or a gearwheel. A fixed pinion is also possible to be replaced by an idler pinion with a coupling device. The double-clutch transmission can further have more gear trains for providing more gears. For example, the double-clutch transmission can include sixth gear train that has a gearwheel sixth gear on the input shaft of even gears, meshing with an idler sixth gear on the layshaft of high gears. Additionally, the double-clutch transmission can include seventh gear train that has a gearwheel seventh gear on the input shaft of odd gears, meshing with an idler seventh gear on the layshaft of high gears.

The powertrain can select suitable gears in response to various speeds and acceleration conditions. The selected gears can maximise fuel utilisation efficiency and speed performance of a vehicle with the power train. The suitable gears also enable improvements on noise, vibration, and harshness. The powertrain can comprise an engine that is connected to the input shafts via the two clutch discs, a crankshaft of the engine being connected to the vehicle speed sensor for measuring an engine speed. In other words, the two input shafts are connected to a gearbox by the double clutch such that the engine provides driving torque to one of the two input shafts at a time. Shifts between the input shafts thus become swift and efficient for minimising disruption in torque transmission.

The engine can comprise an internal combustion engine, an electric motor, a hybrid engine or a combination of any of these engines. These various types of engines make the powertrain more versatile for a variety of energy sources. For example, the powertrain with the electric motor has an excellent speed performance with little emission.

The double-clutch transmission can further comprise a third layshaft arranged in parallel to the input shafts, the first layshaft and the second layshaft. The double-clutch transmission can also comprise a pinion and other gearwheels on the third layshaft for outputting the drive torque. The other gearwheels comprising a reverse gearwheel train for providing a reverse gear. The reverse gear train comprises an idler reverse gear on the third layshaft that meshes with the gearwheels on one of the first layshaft and the second layshaft. The reverse gearwheel train also comprises a coupling device on the third layshaft to engage the idler reverse gear to the third layshaft for providing the reverse gear. The reverse gear enables the vehicle with the double-clutch transmission to be more manoeuvrable for parking.

The idlers of low gears and idlers of high gears are mounted on separate layshafts. The idlers of low gears can include idlers of the first gear, the second gear, and the third gear. The idlers of high gears can include idlers of the fourth gear, the fifth gear, the sixth gear and the seventh gear. Alternatively, the fourth gear can also belong to the group of low gears. Gearwheels of high gears typically have smaller diameters than those of low gears. A layshaft that carries the gearwheels of high gears can have a distance to the input shafts that is shorter than a distance from the input shafts to a layshaft with low gears. This arrangement makes the double-clutch transmission compact.

The present application provides a vehicle with the powertrain for preselecting gears. A linear speed sensor is installed on a body of the vehicle for measuring driving speed of the vehicle. The linear speed sensor sends electrical signals to the transmission control unit for regulating the double-clutch transmission in response to the speed of the vehicle. Automatic selections of gears become feasible for fuel efficiency, low noise of gear shifting and comfort for passengers of the vehicle.

### BRIEF DESCRIPTION OF THE DRAWINGS

The present invention will hereinafter be described in conjunction with the following drawing figures, wherein like numerals denote like elements, and:

FIG. 1 illustrates an expanded view of a double-clutch transmission; and

FIG. 2 illustrates a vehicle installed with the double clutch transmission.

### DETAILED DESCRIPTION

The following detailed description is merely exemplary in nature and is not intended to limit application and uses. Furthermore, there is no intention to be bound by any theory presented in the preceding background or summary or the following detailed description.

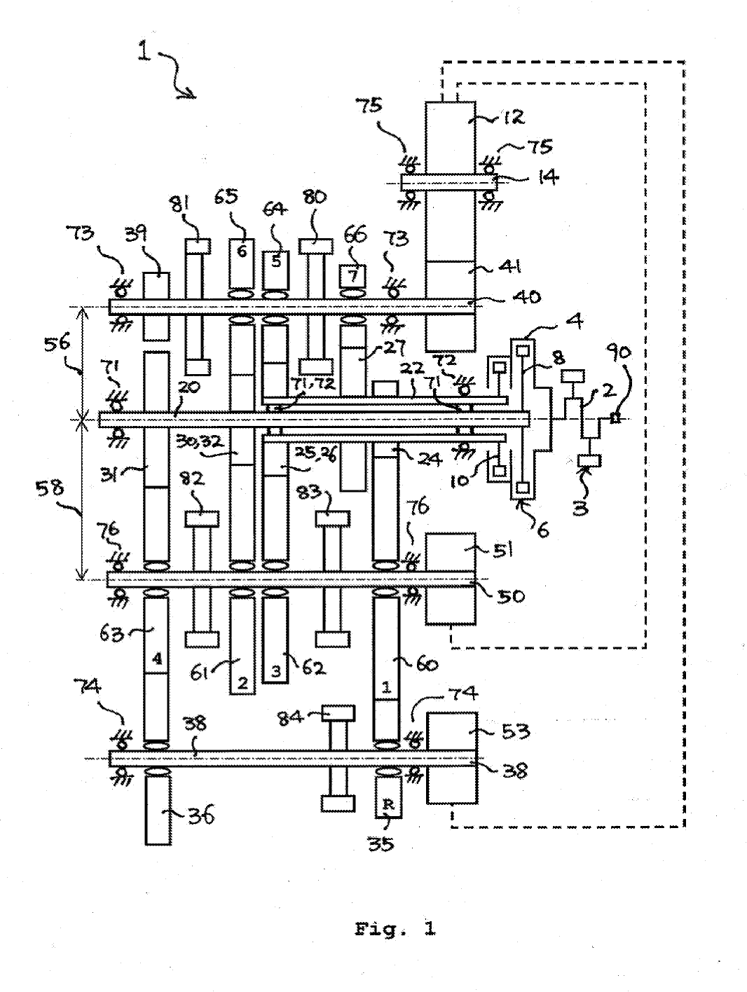

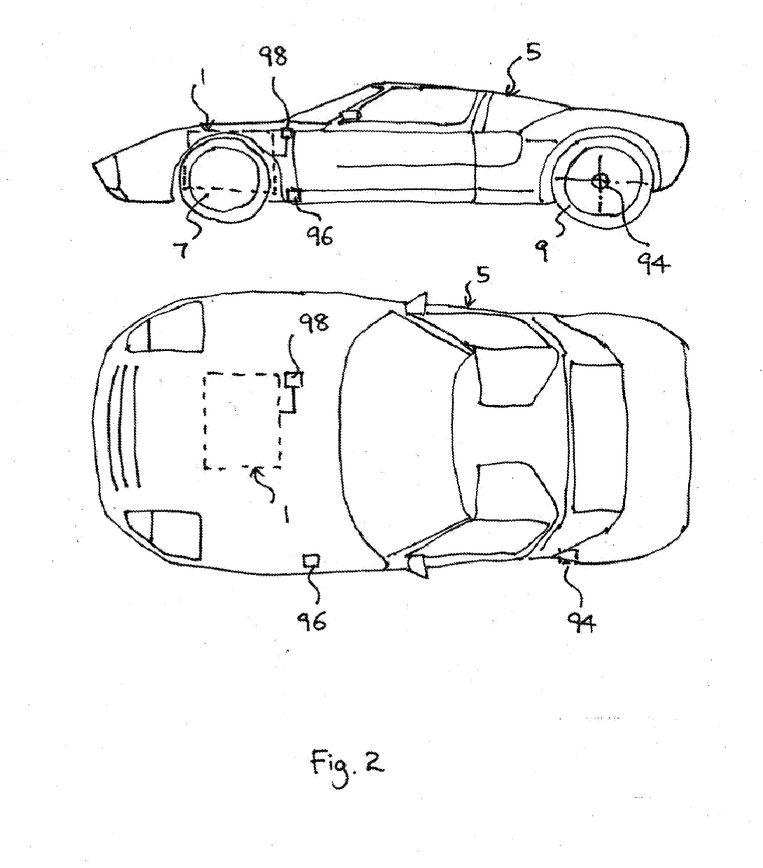

In the following description, details are provided to describe an embodiment of the application. It shall be apparent to one skilled in the art, however, that the embodiment may be practiced without such details. FIG. 1 and FIG. 2 illustrate the embodiment of the present application. These figures comprise parts that have same reference numbers. Description of these parts is hereby incorporated by reference.

In particular, FIG. 1 illustrates an expanded view of a double-clutch transmission 1. The double clutch transmission 1 comprises shafts, gearwheels and a double-clutch 6. The gearwheels are mounted on the shafts that are further connected to an engine 3 via the double clutch 6. According to the FIG. 1, the double clutch transmission 1 comprises following shafts, from top to bottom, an output shaft 14, an upper layshaft 40, two input shafts 20, 22, a lower layshaft 50 and a reverse gear shaft 38. The input shafts 20, 22 comprise a solid input shaft 20 and a hollow input shaft 22. The hollow input shaft 22 encloses the solid input shaft 20 in its core and the solid input shaft 20 protrudes outside the hollow input shaft 22 at its opposite ends. The two input shafts 20, 22 are coaxial.

The hollow input shaft 22 is mounted onto the solid input shaft 20 by a pair of solid shaft bearings 71 that are disposed between the solid input shaft 20 and the hollow input shaft 22 at two ends of the hollow input shaft 22. As a result, the two input shafts 20, 22 are coupled coaxially such that the solid input shaft 20 is free to rotate inside the hollow in-put shaft 22. The assembly of the input shafts 20, 22 is supported by a solid shaft bearing 71 at a protruding end of the solid shaft 20 on the left and by a hollow shaft bearing 72 on the right on the hollow input shaft 22.

As shown in FIG. 1, gearwheels are mounted onto the solid input shaft 20 and the hollow input shaft 22 coaxially. There are two gearwheels mounted on the left exposed portion of the solid input shaft 20. These two gearwheels, from left to right, are a fixed wheel fourth gear 31 and a fixed wheel second gear 30. The fixed wheel second gear 30 also serves as a fixed wheel sixth gear 32. On the hollow input shaft 22, which surrounds a right portion of the solid input shaft 20, there are mounted with a fixed wheel third gear 25, a fixed wheel seventh gear 27 and a fixed wheel first gear 24, from left to right. The fixed wheel third gear 25 also serves as a fixed wheel fifth gear 26.

The lower layshaft 50 is provided below both the solid input shaft 20 and the hollow input shaft 22. There are a number of gearwheels and coupling devices mounted on the lower layshaft 50, which include, from left to right, an idler fourth gear 63, a double-sided coupling device 82, an idler second gear 61, an idler third gear 62, a double-sided coupling device 83, an idler first gear 60 and a lower pinion 51. One lower layshaft bearing 76 is provided between the lower pinion 51 and the idler first gear 60. Another layshaft bearing 73 is provided on a left side of the idler fourth gear 63 at an end of the lower layshaft 50. The lower pinion 51 is fixed onto the lower layshaft 50. The idler first gear 60, the idler third gear 62, the idler second gear 61 and the idler fourth gear 63 are mounted on the lower layshaft 50 by bearings separately such that these gearwheels become idlers, being free to rotate around the lower layshaft 50. In other words, gearwheels of low gears 60, 61, 62, 63 (e.g., 1st, 2nd, 3rd & 4th gears) are installed on the same lower layshaft 50 coaxially. In particular, one of the lower layshaft bearings 76 is installed next to the gearwheel of the lowest gear (i.e. idler first gear 60) and the lower pinion 51. Both the double-sided coupling devices 82, 83 are configured to move along the lower layshaft 50 such that they can either synchronise a gearwheel on their left or right to the lower layshaft 50 respectively. The idler first gear 60 meshes with the fixed wheel first gear 24. The idler third gear 62 meshes with the fixed wheel third gear 25. The idler second gear 61 meshes with the fixed wheel second gear 30. The idler fourth gear 63 meshes with the fixed wheel fourth gear 31.

The upper layshaft 40 is installed above the input shafts 20, 22. Gearwheels and coupling devices are mounted onto the upper layshaft 40, including, from left to right, a park-lock gearwheel 39, a single-sided coupling device 81, an idler sixth gear 65, an idler fifth gear 64, a double-sided coupling device 80, an idler seventh gear 66 and an upper pinion 41. One upper layshaft bearing 73 is positioned between the upper pinion 41 and the idler seventh gear 66. Another layshaft bearing 73 is positioned at an end of the upper layshaft 40, next to the park-lock gearwheel 39. In other words, gearwheels of high gears 64, 65, 66 (e.g. 5th, 6th & 7th gears) reside on the same upper layshaft 40. The idler seventh gear 66, the idler fifth gear 64, and the idler sixth gear 65 are mounted on the upper layshaft 40 by bearings respectively such that these gearwheels are free to rotate around the upper layshaft 40. The double-sided coupling device 80 is configured to move along the upper layshaft 40 to engage or disengage any of the idler seventh gear 66 and the idler fifth gear 64 to the upper layshaft 40. The single-sided coupling device 81 is configured to move along the upper layshaft 40 to engage or disengage the idler sixth gear 65 to the upper layshaft 40. The idler seventh gear 66 meshes with the fixed wheel seventh gear 27. The idler fifth gear 64 meshes with the fixed wheel fifth gear 26. The idler sixth gear 65 meshes with the fixed wheel sixth gear 32.

The park-lock gearwheel 39 comprises a park-lock on the upper layshaft 40 that carries a final drive pinion 41. The park-lock is a wheel which is provided with a ratchet device, with a click device having a rack element, a claw or similar. The park-lock keeps the upper layshaft 40, the upper pinion 41 and the output shaft 14 from rotating, which stops a vehicle 5 with the double-clutch transmission 1 from running when parked. Detailed structure of the park-lock is not shown in FIG. 1.

The output shaft 14 is situated above the upper layshaft 40. The output layshaft 14 has an output gear wheel 12 fixed onto it in the middle. Two opposite ends of the output shaft 14 are attached and supported by two output shaft bearings 75 respectively. The output gearwheel 12 meshes with the upper pinion 41 and the lower pinion 51.

In contrast to the output shaft 14, the reverse gear layshaft 38 is located below the lower layshaft 50. The reverse gear layshaft 38 carries a second idler reverse gear 36, a double-sided coupling device 84, an idler reverse gear 35 and a reverse pinion 53, from left to right. One reverse gear shaft bearing 74 that supports the reverse gear layshaft 38 is installed between the idler reverse gear 35 and the reverse pinion 53. Another reverse gear shaft bearing 74, which also supports the reverse gear shaft 38, is attached to a left end of the reverse gear shaft 38. The reverse pinion 53, the idler reverse gear 35, the double-sided coupling device 84, and the second idler reverse gear 36 are mounted onto the reverse gear shaft 38 coaxially. The idler reverse gear 35 and the second idler reverse gear 36 are installed onto the reverse gear layshaft 38 by bearings such that the idler reverse gear 35 and the second idler reverse gear 36 can freely rotate around the reverse gear shaft 38. The double-sided coupling device 84 is configured to move along the reverse gear shaft 38 to synchronise either the idler reverse gear 35 or the second idler reverse gear 36 with the reverse gear shaft 38. The idler reverse gear 35 meshes with the idler first gear 60. The second idler reverse gear 36 meshes with the idler fourth gear 63. The reverse pinion 53 meshes with the output gearwheel 12.

In the double clutch transmission 1, there are three double-meshing features and one triple-meshing feature. A first double meshing feature comprises that the fixed wheel third gear 25 meshes with both the idler third gear 62 and the idler fifth gear 64 separately. A second double meshing comprises that the fixed wheel second gear 30 meshes with the idler second gear 61 and the idler sixth gear 65 separately. A third double meshing feature comprises that the idler first gear 60 meshes with the fixed wheel first gear 24 and the idler reverse gear 35. The triple-meshing feature comprises that the output gearwheel 12 meshes with the upper pinion 41, the lower pinion 51 and the reverse pinion 53.

A distance 56 between the input shafts 20, 22 and the upper lay-shaft 40 is smaller than a distance 58 between the input shafts 20, 22 and the lower layshaft 50. The distance 56 between the input shafts 20, 22 and the upper layshaft 40 is measured from a common longitudinal axis of the input shafts 20, 22 to a longitudinal axis of the upper layshaft 40. Similarly, the distance 58 between the input shafts 20, 22 and the lower layshafts 50 is measured from the common longitudinal axis of the input shafts 20, 22 to a longitudinal axis of the lower layshaft 50. The difference exists because the gearwheels of high gears 64, 65, 66 have smaller diameters than the diameters of the gearwheels of low gears 60, 61, 62, 63. In other words, the upper layshaft 40 is brought to be closer to the input shafts 20, 22 than the lower layshaft 50.

The double clutch 6 has an inner clutch disc 8 and an outer clutch disc 10, which are fixed to the solid input shaft 20 and the hollow input shaft 22 respectively. The two clutch discs 8, 10 are enclosed by a clutch housing 4. The clutch housing 4 and the two clutch discs 8, 10 are connected to each other by other components that are not shown. The other components enable the clutch housing 4 to engage any of the two clutch discs 8, 10 at a time for torque transmission. The inner clutch disc 8 and the clutch housing 4 are parts of an inner clutch of the double-clutch transmission 1, whilst the outer clutch disc 10 and the clutch housing 4 are parts of an outer clutch of the double-clutch transmission 1.

The clutch housing 4 is attached to the engine 3. Specifically, a crankshaft 2 is fixed to the clutch housing 4 at an end. The clutch housing 4 thus receives torque from the engine 3 for driving any of the two input shafts 20, 22. The clutch housing 4 has a larger outer diameter around the inner clutch disc 8 than that around the outer clutch disc 10. Correspondingly, the inner clutch disc 8 has a larger outer diameter than that of the outer clutch disc 10 inside the clutch housing 4. The fact that the larger inner clutch disc 8 on the solid input shaft 20 drives the first gear makes the double clutch transmission 1 robust.

The engine 3 encloses the crankshaft 2 inside an engine block although the engine block is omitted from FIG. 1. Another end of the crankshaft 2 is installed with a vehicle speed sensor 90. The vehicle speed sensor 90 is also known as an output speed sensor that sends varying frequency signal to the transmission control unit 98 via cables to determine the rotational speed of the engine 3. The transmission control unit 98 evaluates the signals and determines rotational speeds and rotational acceleration of the crankshaft 2. The rotational speed of the crankshaft 2 corresponds to the engine speed, whilst the rotational acceleration of the crankshaft 2 is engine acceleration. In short, the transmission control unit 98 assesses engine speed and engine acceleration of the double clutch transmission 1. The vehicle speed sensor 90 may also be known as an output speed sensor (OSS). The vehicle speed sensor 90 sends the speed and acceleration information to the transmission control unit 98 to determine when a gear change should take place.

FIG. 2 illustrates a vehicle 5 that is installed with the double clutch transmission 1. The vehicle 5 has two front wheels and two rear wheels at bottom. The double-clutch transmission 1 is installed into a body of the vehicle 5. The vehicle 5 has two front wheels 7 and two rear wheels 9. The two rear wheels 9 receive the torque from the double clutch transmission 1 via a differential (not shown) that is further coupled to the output gearwheel 12.

A wheel speed sensor 94 is attached to a shaft 88 that joins the rear wheels. The wheel speed sensor determines a speed of the vehicle 5 and sends electrical signals of the vehicle speed to the transmission control unit 98. The wheel speed sensor 94 is also connected to the engine control unit via cables. The wheel speed sensor 94 senses rotational speed variations of the shaft such that the engine control unit can assess accelerations of the vehicle based on received electrical signals from the wheel speed sensor 94.

A linear speed sensor 96 is mounted on the body of the vehicle. The linear speed sensor 96 is linked to the transmission control unit 98 by cables. The linear speed sensor 96 detects respective movements between the body and ground such that speeds of the vehicle are obtained for calculation by the engine control unit.

In the present specification, the expressions “mesh” and “comb” with respect to geared wheels or engaged gearwheels are provided as synonyms. The solid input shaft 20 is alternatively termed as an inner input shaft 20, while the hollow input shaft 22 is alternatively termed as an outer input shaft 22. The solid input shaft 20 is alternatively replaced by a hollow shaft that is disposed inside the hollow input shaft 22. The term “coupling device” is alternatively termed as “shifting mechanism” or “synchroniser” for engaging or disengaging its adjacent gearwheels to a shaft. The coupling device enables a gearwheel and its weight-carrying shaft that rotates at different speeds to be adjusted to the same speed and then locked together for torque transmission. The double-clutch transmission is alternatively termed as twin-clutch double-clutch transmission, double-clutch, double clutch transmission or dual clutch transmission. “Wires” may replace the term “cable” that serves the function of making electrical connections. The tern “gear” is a short form of “gear speed” or “gear speeds”.

The fixed wheel first gear 24 is also known as the first fixed gearwheel 24. The fixed wheel third gear 25 is also known as the third fixed gearwheel 25. The fixed wheel fifth gear 26 is also known as the fifth fixed gearwheel 26. The fixed wheel seventh gear 27 is also known as the seventh fixed gearwheel 27. The fixed wheel second gear 30 is also known the second fixed gearwheel 30. The fixed wheel fourth gear 31 is also known as the fourth fixed gearwheel 31. The fixed wheel sixth gear 32 is also known as the sixth fixed gearwheel 32. The idler first gear 60 is also known as the first gear idler gearwheel 60. The idler second gear 61 is also known as the second gear idler gearwheel 61. The idler third gear 62 is also known as the third gear idler gearwheel 62. The idler fourth gear 63 is also known as the fourth gear idler gearwheel 63. The idler fifth gear 64 is also known as the fifth gear idler gearwheel 64. The idler sixth gear 65 is also known as the sixth gear idler gearwheel 65. The idler seventh gear 66 is also known as the seventh gear idler gearwheel 66. The idler reverse gear 35 is also known as a reverse gear idler gearwheel 35. Any of the input shafts 20, 22, the layshafts 38, 40, 50 and the output shaft 14 can be supported by more than two bearings.

In figures of the present application, dash lines represent combing relationship between gearwheels that are linked to the dash lines.

The double clutch transmission 1 permits gearshift operations with less loss of driving torque. This is because the gearshift operations can be achieved by selectively connecting one of the two clutch discs 8, 10 of the double-clutch transmission 1. Therefore, an associated additional main drive clutch can be avoided. The selective connection between the two clutches also enables the realization of an automatic transmission that can be operated without interruptions in propulsive power. The propulsive power comprises momentum derived from the rotating gearwheels and shafts inside the double-clutch transmission 1. Such a transmission is similar in design to a mechanical manual transmission and it has correspondingly very low friction losses. The double-clutch transmission 1 further provides a parallel manual transmission that can be used for transverse installation in a front-wheel drive vehicle.

The double-clutch transmission 1 can be connected similar to a known manual transmission, such as a parallel manual transmission. In the known that a manual transmission, a drive shaft for a front axle of the vehicle 5 extends outward from its double-clutch transmission case, and parallel to the output shaft 14 of the double-clutch transmission 1. The arrangement of the known manual transmission provides little space left for actuation of the manual transmission and clutch, and for an optional electric motor. The optional electric motor can act as a starter device for the internal combustion engine 3, as an energy recuperation device for brake operation or as an additional drive means in hybrid vehicles. Having such little space presents a number of difficulties that are solved or at least alleviated by the application. The double-clutch transmission 1 has two clutches 8, 10 for connecting to an electrical motor and the manual transmission in a compact manner.

The double-clutch transmission 1 provides a compact structure of a parallel transmission. The parallel transmission includes two input shafts 20, 22, each of which can be non-rotatably coupled via its own clutch discs 8, 10 to the engine 3. The double-clutch transmission 1 further provides the output shaft 14 that is parallel to the input shafts 20, 22. The double-clutch transmission 1 is particularly well suited for transverse installation in front-wheel drive vehicles, in which the front differential, for example, is positioned below the pinions 41, 51, 53. A short overall length of the power train for transmitting torques can be achieved. The double-clutch transmission 1 provides three relatively small pinions 41, 51, 53 on three intermediately arranged layshafts 40, 50, 38 that combs with one relatively big output gearwheel 12 that in turn is connected with the output shaft 14. This arrangement provides a compact and lightweight double-clutch transmission 1.

The double-clutch transmission 1 further allows a design in which the output gearwheel 12 is integrated into a transmission differential device without providing an intermediate output shaft 14. This allows a very dense packaging situation for the double-clutch transmission 1.

It is further advantageous to provide fixed wheels of the even gearwheels on one input shaft and fixed wheels of the odd gears on another input shaft. This arrangement provides the above-mentioned power-shift operation in a smooth and efficient manner when gearshift is performed sequentially. This is because the double-clutch transmission 1 can alternatively engage one of the two clutches to select gearwheels of the two input shafts 20, 22 during the speed escalation. For example, the power-shift operation from the first gear to the fourth gear causes the hollow input shaft 22 and the solid input shaft 20 being engaged alternatively, which is energy efficient and fast for switching the driving torque between the two input shafts 20, 22.

The double-meshing feature of the idler third gear 62 and the idler fifth gear 64 via the intermediate fixed wheel third gear 25 (i.e., fixed wheel fifth gear 26) provides swift and efficient gearshifts between the third gear and the fifth gear. No input shaft or clutch change is required for the direct gearshift between the two gears. Since the fixed wheel third gear 25 is the same as the fixed wheel fifth gear 26, no additional gearwheel is required for providing each of the third and fifth gears. Weight of the double-clutch trans-mission 1 is reduced as comparing to having two separate gearwheels (i.e. fixed wheel third gear 25 & fixed wheel fifth gear 26).

In a similar manner, the other double meshing feature of the idler second gear 61 and the idler sixth gear 65 via the intermediate fixed wheel second gear 30 (i.e. fixed wheel sixth gear 32) also provides fast and efficient gearshifts. Weight of the double-clutch transmission 1 is further reduced as comparing to having two separate gearwheels (i.e. fixed wheel second gear 30 & fixed wheel sixth gear 32).

Gearwheels 60, 61, 62, 63 of the low gears (i.e., 1st, 2nd, 3rd & 4th) that are provided on the same lower layshaft 50 are advantageous. This is because the lower layshaft 50 has lower rotational speed with larger size for transmitting stronger torque, as compared to that of the upper layshaft 40. This arrangement eliminates the need of providing multiple layshafts with larger size for carrying those heavy load gearwheels 60, 61, 62, 63 of the low gears (i.e., 1st, 2nd, 3rd & 4th) separately. Therefore, the double-clutch trans-mission 1 can be made light at less cost.

Lower layshaft bearings 76 on the lower layshaft 50 are mounted adjacent to the gearwheel 60 of low gears (e.g. 1st gear) and the lower pinion 51. This arrangement provides stronger mechanical support to the lower layshaft 50 for less shaft deflection. Similarly, the layshaft bearing 73, 76 and the idler shaft bearing 74 are provided next to the pinions 41, 51, 53 for stronger support. As a result, the layshafts 40, 50 and the reverse gear shaft 38 can be reduced in weight for lower cost.

A variant of the embodiment with two double-shared gearwheels on two different input shafts 20, 22 has the advantage of providing a higher ratio-flexibility and less dependency. In the current example of double-clutch transmission 1, gearshifts between the third and fifth gears can be faster because both the idler fifth gear 64 and the idler third gear 62 are engaged to the same fixed wheel third gear 25 all the time, thus readily available for the selection. It is beneficial to provide the gearwheels of the first gear, of the reverse gear, of the output gear wheel 12 and of the pinions 41, 51, 53 close to the bearings for sturdy supporting. These gearwheels undergo bigger forces than those of the higher gears (e.g., idler fifth gear 64) because the drive ratio is higher for the lower gears and the reverse gear. Therefore, their shafts must take up higher driving forces. If those forces are taken up close to the support points of the shafts, a reduced shaft bending will occur.

The double-clutch transmission 1 is configured to transmit seven forward gears and two reverse gears. The double-clutch transmission 1 provides a first gear when the clutch housing 4 engages the outer clutch disc 10 and the double-sided coupling device 83 locks the idler first gear 60 to the lower layshaft 50. The clutch housing 4 is detached from the inner clutch disc 8. A torque of the first gear is transmitted from the crankshaft 2, via the clutch housing 4, via the outer clutch disc 10, via the hollow input shaft 22, via the fixed wheel first gear 24, via the idler first gear 60, via the double-sided coupling device 83, via the lower layshaft 50, via the lower pinion 51, via the output gear wheel 12, to the output shaft 14. The number of tooth engagements or engaged gear pairs for the torque transfer of the first gear is three.

The double-clutch transmission 1 provides a second gear when the clutch housing 4 engages the inner clutch disc 8 and the double-sided coupling device 82 locks the idler second gear 61 to the lower layshaft 50. The clutch housing 4 disengages the outer clutch disc 10. A torque of the second gear is transmitted sequentially from the crankshaft 2, the clutch housing 4, the inner clutch disc 8, the solid input shaft 20, the fixed wheel second gear 30, the idler second gear 61, the double-sided coupling device 82, the lower layshaft 50, the lower pinion 51, the output gear wheel 12, to the output shaft 14. The number of tooth engagements or engaged gear pairs for the torque transfer of the first gear is again three.

The double-clutch transmission 1 provides a third gear when the clutch housing 4 engages the outer clutch disc 10 and the double-sided coupling device 83 locks the idler third gear 62 to the lower layshaft 50. The clutch housing 4 further disengages the inner clutch disc 8. A torque of the third gear is transmitted sequentially from the crankshaft 2, the clutch housing 4, the outer clutch disc 10, the hollow input shaft 22, the fixed wheel third gear 25, the idler third gear 62, the double-sided coupling device 83, the lower layshaft 50, the lower pinion 51, the output gear wheel 12, to the output shaft 14. The number of tooth engagements or engaged gear pairs for the torque transfer of the first gear is also three.

The double-clutch transmission 1 provides a fourth gear when the clutch housing 4 engages the inner clutch disc 8 and the double-sided coupling device 82 locks the idler fourth gear 63 to the lower layshaft 50. The clutch housing 4 disengages the outer clutch disc 10 for transmitting the fourth gear. A torque of the fourth gear is transmitted sequentially from the crankshaft 2, the clutch housing 4, the inner clutch disc 8, the solid input shaft 20, the fixed wheel fourth gear 31, the idler fourth gear 63, the double-sided coupling device 82, the lower layshaft 50, the lower pinion 51, the output gear wheel 12, to the output shaft 14. The number of tooth engagements or engaged gear pairs for the torque transfer of the first gear is three.

The double-clutch transmission 1 provides a fifth gear when the clutch housing 4 engages the outer clutch disc 10 and the double-sided coupling device 80 locks the idler fifth gear 64 to the upper layshaft 40. The clutch housing 4 further disengages the inner clutch disc 8. A torque of the fifth gear is transmitted sequentially from the crankshaft 2, the clutch housing 4, the outer clutch disc 10, the hollow input shaft 22, the fixed wheel fifth gear 26, the idler fifth gear 64, the double-sided coupling device 80, the upper layshaft 40, the upper pinion 41, the output gear wheel 12, to the output shaft 14. The number of tooth engagements or engaged gear pairs for the torque transfer of the first gear is also three.

The double-clutch transmission 1 provides a sixth gear when the clutch housing 4 engages the inner clutch disc 8 and the single-sided coupling device 81 locks the idler sixth gear 65 to the upper layshaft 40. The clutch housing 4 disengages the outer clutch disc 10 for transmitting the sixth gear. A torque of the sixth gear is transmitted sequentially from the crankshaft 2, the clutch housing 4, the inner clutch disc 10, the solid input shaft 20, the fixed wheel sixth gear 32, the idler sixth gear 65, the single-sided coupling device 81, the upper layshaft 40, the upper pinion 41, the output gear wheel 12, to the output shaft 14. The number of tooth engagements or engaged gear pairs for the torque transfer of the first gear is three.

The double-clutch transmission 1 provides a seventh gear when the clutch housing 4 engages the outer clutch disc 10 and the double-sided coupling device 80 locks the idler seventh gear 66 to the upper layshaft 40. The clutch housing 4 further disengages the inner clutch disc 8. A torque of the seventh gear is transmitted sequentially from the crankshaft 2, the clutch housing 4, the outer clutch disc 10, the hollow input shaft 22, the fixed wheel seventh gear 27, the idler seventh gear 66, the double-sided coupling device 80, the upper layshaft 40, the upper pinion 41, the output gear wheel 12, to the output shaft 14. The number of tooth engagements or engaged gear pairs for the torque transfer of the first gear is also three.

As illustrated above, the double-clutch transmission 1 provides two reverse gears. The vehicle 5 moves with a first reverse gear when the clutch housing 4 engages the outer clutch disc 10 and the double-sided coupling device 84 locks the idler reverse gear 35 to the reverse gear layshaft 38. The clutch housing 4 also disengages the inner clutch disc 8. A torque of the first reverse gear is transmitted from the crankshaft 2, via the clutch housing 4, via the outer clutch disc 10, via the hollow input shaft 22, via the fixed wheel first gear 24, via the idler first gear 60, via the idler reverse gear 35, via the double-sided coupling device 84, via the reverse gear layshaft 38, via the reverse pinion 53, via the output gear wheel 12, to the output shaft 14.

The vehicle 5 moves with a second reverse gear when the clutch housing 4 engages the inner clutch disc 8 and the double-sided coupling device 84 locks the second idler reverse gear 36 to the reverse gear layshaft 38. The clutch housing 4 also disengages the outer clutch disc 10. A torque of the second reverse gear is transmitted from the crankshaft 2, via the clutch housing 4, via the inner clutch disc 8, via the solid input shaft 20, via the fixed wheel fourth gear 31, via the idler fourth gear 63, via the second idler reverse gear 36, via the double-sided coupling device 84, via the reverse gear layshaft 38, via the reverse pinion 53, via the output gear wheel 12, to the output shaft 14.

The above-mentioned nine torque flow paths not only provide viable solutions to generate nine gears of the double-clutch transmission 1, but also offer possibilities of switching from one gear to the other efficiently. For example, gear jumps from the second gear to the sixth gear is efficiently provided by the double-meshing of the idler second gear 61 and the idler sixth gear 65 via an intermediate gearwheel, namely the fixed wheel second gear 30. The gear jump from the second gear to the sixth gear does not require stopping the solid input shaft 20. Furthermore, the double-meshing of the idler second gear 61 and the idler sixth gear 65 avoids the need of providing two separate fixed gearwheels on an input shaft. In other words, less space is required on the solid input shaft 20 because two fixed gearwheels 30, 32 are combined into a single one. The double-clutch transmission 1 can thus be made lighter and cheaper by the reduction of one gearwheel. The other double meshing of the idler third gear 62 and the idler fifth gear 64 via the fixed wheel third gear 25 provides similar benefits.

The double meshing features further provide additional gear changes at high efficiency. Any gear of the first double meshing feature can be switched to another by selecting one of the input shafts 20, 22. For example, gear changing from the sixth gear to the third gear can be achieved by deselecting the solid input shaft 20 and selecting the hollow input shaft 22. When using the park-lock, the park-lock gearwheel 39 on the upper layshaft 40 can be easily engaged to lock the output shaft 14, via the upper layshaft 40, via the upper pinion 51, via the output gear wheel 12.

In providing gear meshing or combing for torque transmission, less number of gear tooth engagement (i.e., gear engagement) is preferred. The less number of gear tooth engagement provides lower noise and more efficient torque transmission. Examples of the less number of gear tooth engagement are found in some of the above-mentioned torque flow paths. The double-clutch transmission 1 enables pre-selection of gears as a function of vehicle acceleration. The pre-selection is also known as pre-synchronisation. The pre-selection causes an idler gearwheel of a next-expected gear to be engaged to its weight-carrying layshaft. The acceleration comprises increase or decrease in speed of the vehicle 5.

In a process of acceleration, the wheel speed sensor 94 detects acceleration of rotational speed of the vehicle 5. The linear speed sensor 96 also sends electrical signals to the transmission control unit 98 indicating that the vehicle 5 is increasing its speed. The vehicle 5 is accelerated from the first gear such that the double-sided coupling device 83 engages the idler first gear 60 to the lower layshaft 50. The driving torque from the engine 3 is transmitted to the output gearwheel 12 via the clutch housing 4, via the outer clutch disc 10, via the hollow input shaft 22, via the fixed wheel first gear 24, via the idler first gear 60, via the double-sided coupling device 83, via the lower layshaft 50, via the lower pinion 51, to the output gearwheel 12. In the mean time, the double-sided coupling device 82 also engages the idler second gear 61 because the transmission control unit 98 expects the next gear of the acceleration is the second gear. Due to the pre-selection of the second gear, the inner clutch disc 8, the solid input shaft 20, the fixed wheel second gear 30, the idler second gear 61, and the double-sided coupling device 82 are driven by the lower layshaft 50. In other words, the solid input shaft 20 is freewheeling. Once the clutch housing 4 switches its connection from the outer clutch disc 10 to the inner clutch disc 8, the vehicle immediately drives at the second gear.

When the transmission control unit 98 receives signals from the wheel speed sensor 94 and the linear speed sensor 96 indicating that the vehicle 5 continues the acceleration, the double-sided coupling device 83 detaches the idler first gear 60 from the lower layshaft 50 and subsequently the double-sided coupling device 83 engages the idler third gear 62. At this moment, the hollow input shaft 22 is freewheeling. As the vehicle continues to accelerate, an idler gearwheel of a next-expected gear is engaged, but receiving no driving torque for the moment.

In a process of deceleration, the wheel speed sensor 94 detects deceleration of rotational speed of the vehicle 5. The linear speed sensor 96 also gives electrical signals to the transmission control unit 98 signifying that the vehicle 5 is decreasing its speed. The vehicle 5 is decelerated from the seventh gear such that the double-sided coupling device 80 engages the idler seventh gear 66 to the upper layshaft 40. The driving torque from the engine 3 is transmitted to the output gearwheel 12 via the clutch housing 4, via the outer clutch disc 10, via the hollow input shaft 22, via the fixed wheel seventh gear 27, via the idler seventh gear 66, via the double-sided coupling device 80, via the upper layshaft 40, via the upper pinion 41, to the output gearwheel 12. In the mean time, the single-sided coupling device 81 also connects the idler sixth gear 65 because the transmission control unit 98 expects the next gear of the deceleration is the sixth gear. Due to the pre-selection of the sixth gear, the inner clutch disc 8, the solid input shaft 20, the fixed wheel sixth gear 32, the idler sixth gear 65, and the single-sided coupling device 81 are driven by the upper layshaft 40. In other words, the solid input shaft 20 is freewheeling. Once the clutch housing 4 switches its engagement from the outer clutch disc 10 to the inner clutch disc 8, the vehicle 5 promptly cruises at the sixth gear.

When the transmission control unit 98 receives signals from the wheel speed sensor 94 and the linear speed sensor 96 indicating that the vehicle 5 continues the deceleration, the double-sided coupling device 80 detaches the idler seventh gear 66 from the upper layshaft 40 and subsequently the double-sided coupling device 80 engages the idler fifth gear 64. At this moment, the hollow input shaft 22 is freewheeling. As the vehicle continues to decelerate, an idler gearwheel of a next-expected gear is engaged, but receiving no driving torque for the moment.

The double clutch transmission 1 also enables the pre-selection of gears as a function of engine speed. The vehicle speed sensor 90 that is mounted on the crankshaft 2 measures the engine speed. The transmission control unit 98 receives electrical signals from the vehicle speed sensor 90 for deciding speed of the engine 3. When the engine 3 runs at 4000 RPM (round per minute), the vehicle 5 drives at the third gear such that the double-sided coupling device 83 engages the idler third gear 62 to the lower layshaft 50. Once the vehicle speed sensor 90 detects that the rotational speed of the engine 3 increases, the double-sided coupling device 82 engages the idler fourth gear 63 to the lower layshaft 50 such that the solid input shaft 20 and the inner clutch disc 8 are freewheeling. In other words, the escalation of engine speed causes the transmission control unit 98 to preselect the fourth gear.

As a driver continue to press an acceleration pedal down, the clutch housing 4 disconnects the outer clutch disc 10 and locks onto the inner clutch disc 8. Thus, the vehicle 5 immediately runs at the fourth gear because the output gearwheel 12 receives the driving torque from the engine 3 via the idler fourth gear 63. The idler third gear 62, the fixed wheel third gear 25 and the hollow input shaft 22 are freewheeling, also driven by the lower layshaft 50. Shortly after, the double-sided coupling device 80 locks the idler fifth gear 64 to the upper layshaft 40. The upper pinion 40, the upper layshaft 40, the idler fifth gear 64, the double-sided coupling device 80, the fixed wheel fifth gear 26 and the hollow input shaft 22 then follow the rotation of the output gearwheel 12 for freewheeling.

The clutch housing 4 disengages the inner clutch disc 8 and engages the outer clutch disc 10 when the engine speed keeps increasing. Consequently, the vehicle 5 runs at the fifth gear. In the mean time, the double-sided coupling device 82 detaches from the idler fourth gear 63 and the single-sided coupling device 81 attaches the idler sixth gear 65 to the upper layshaft 40. Accordingly, the sixth gear is preselected when the engine speed increases.

Pre-selection of gear also applies when the engine speed decreases. When the vehicle 5 drives at the fifth gear, the double-sided coupling device 82 connects the idler fourth gear 63 to the lower layshaft 50 although the driving torque is transferred from the engine 3 to the idler fifth gear 64 and the double-sided coupling device 80 for driving. The pre-selection of fourth gear is controlled by the transmission control unit 98 that predicts the next gear of speed to be the fourth gear based on knowledge of lowering engine speed at the fifth gear.

As the driver moves his foot away from the acceleration pedal, the engine speed further reduces. The further reduction of engine speed is sensed by the vehicle speed sensor 90 such that the transmission control unit 98 brings the double-sided coupling device 80 away from the idler fifth gear 64. Shortly afterwards, the double-sided coupling device 82 engages the idler fourth gear 63 to the lower layshaft 50 for driving at the fourth gear. Subsequently, the double-sided coupling device 83 locks the idler third gear 62 to the lower layshaft 50 for preselecting the third gear. Further pre-selections of lower gears follow similar steps that are described for engine speed reduction from the fifth gear to the fourth gear.

The double-clutch transmission 1 further enables the pre-selection of gear as a combined function of vehicle acceleration and engine speed. A pre-selection of a lower gear is performed when the transmission control unit 98 identifies vehicle's deceleration and reduction of engine speed. A pre-selection of a higher gear is carried out when the transmission control unit 98 confirms vehicle's acceleration and increase of engine speed. These schemes are programmed in the transmission control unit 98.

In a case of pre-selection of a lower speed, the vehicle 5 firstly drives at the fifth gear. The diving torque is transmitted from the engine 3 to the output gearwheel 12 via the idler fifth gear 64. The vehicle's acceleration is monitored by the transmission control unit 98 that receives electrical signals from the linear speed sensor 96 and the wheel speed sensor 94. The engine speed is also checked by the transmission control unit 98 by taking electrical signals from the vehicle speed sensor 90.

Once the transmission control unit 98 determines that the vehicle 5 is decelerating and the engine 3 is reducing its speed, the fourth gear is pre-selected such that the double-sided coupling device 82 connects the idler fourth gear 63 to the lower layshaft 50. At this moment, the vehicle 5 still drives at the fifth gear and the outer clutch disc 8 is attached to clutch housing 4 for transmitting the driving torque from the engine 3 to the idler fifth gear 64 via the hollow input shaft 22. However, the inner clutch disc 10 is detached from the clutch housing 4.

When a trend of vehicle's deceleration and the engine's reduction in speed persists, the clutch housing 4 switches its connection from the outer clutch disc 10 to the inner clutch disc 8. Immediately, the vehicle 5 moves at the fourth gear. Afterwards, the double-sided coupling device 80 moves away from the idler fifth gear 64 whilst the double-sided coupling device 83 locks the idler third gear 62 to the lower layshaft 51. The driving torque is transferred from the crankshaft 2 to the idler fourth gear 63 via the solid input shaft 20, whilst the hollow input shaft 22 is freewheeling.

As the vehicle 5 continues to decelerate and the engine 3 resists the reduction in speed, the double-clutch transmission 1 shifts its gear from the fourth gear to the third gear. The pre-selection of gear also becomes the second gear when the vehicle 5 cruises at the third gear. The shifting to the third gear and the pre-selection of the second gear follow similar fashion that are descried above for the shifting to the fourth gear and the pre-selection of the third gear.

In a case of pre-selection of a higher speed, the vehicle 5 firstly drives at the fifth gear. The driving torque is transmitted from the engine 3 to the output gearwheel 12 via the idler fifth gear 64. Once the transmission control unit 98 notices that the vehicle 5 is accelerating and the engine 3 is increasing its speed, the sixth gear is pre-selected that the single-sided coupling device 81 connects the idler sixth gear 65 to the upper layshaft 40. At this moment, the vehicle 5 still drives at the fifth gear and the outer clutch disc 10 is attached to clutch housing 4 for transmitting the driving torque from the engine 3 to the idler fifth gear 64 via the hollow input shaft 22. However, the inner clutch disc 8 is detached from the clutch housing 4.

When a trend of vehicle's acceleration and the engine's increase in speed persist, the clutch housing 4 switches its connection from the outer clutch disc 10 to the inner clutch disc 8. Immediately, the vehicle 5 moves at the sixth gear when the singe-sided coupling device 81 locks the idler sixth gear 65 to the upper layshaft 41. Afterwards, the double-sided coupling device 80 moves away from the idler fifth gear 64. The driving torque is transferred from the crankshaft 2 to the idler sixth gear 65 via the solid input shaft 20, whilst the hollow input shaft 22 is freewheeling. The seventh gear is preselected that the double-sided coupling device 80 locks the idler seventh gear 66 to the upper layshaft 40.

As the vehicle 5 continues to accelerate and the engine 3 resists the increase in speed, the double-clutch transmission 1 shifts its gear from the sixth gear to the seventh gear. Further pre-selection of a higher gear no longer exists.

The double-clutch transmission 1 provides gear pre-selection as a functional of vehicle acceleration, of engine speed or in combination of both. When pre-selection is a function of vehicle acceleration, the double-clutch transmission 1 engages a gear that is high than the currently using gear if the vehicle 5 accelerates. The double-clutch transmission 1 selects a gear that is lower than the currently using gear if the vehicle 5 decelerates. By adding vehicle acceleration to pre-selection strategy, a precise preselecting point is determined for enhance performance and riving experience of the vehicle 5.

When pre-selection is a function of engine speed, the double-clutch transmission 1 engages a gear that is high than a currently using gear if the engine 3 runs faster than a predetermined engine speed. The double-clutch transmission 1 selects a gear that is lower than the currently using gear if the engine 3 runs slower than the predetermined engine speed. By adding engine speed to pre-selection strategy, a precise preselecting point is determined for enhance performance and riving experience of the vehicle 5.

When pre-selection is a function of both the vehicle acceleration and the engine speed, the double-clutch transmission 1 engages a gear that is high than a currently using gear if the vehicle 5 accelerates and the engine 3 runs faster than a predetermined engine speed. The double-clutch transmission 1 selects a gear that is lower than the currently using gear if the vehicle 5 decelerates and the engine 3 runs slower than the predetermined engine speed.

The pre-selection function that depends on both the engine speed and the vehicle acceleration is used in different driving modes. In a normal or an economy-driving mode, the transmission control unit 98 selects a neutral gear to be a preselected gear most of the time for high gearbox efficiency. In a manual mode where the driver determines a present gear, however, the transmission control unit 98 will preselect a gear that is higher than the present gear most of the time because up-shift of gear is normally slower than downshift of gear. Since the pre-selection function depends on both the engine speed and the vehicle acceleration, it is easy to recalibrate the transmission control unit 98 for the various driving modes.

In the scheme, that the pre-selection of gear depending on both the vehicle acceleration and the engine speed, the transmission control unit 98 eliminates potential confusions on preselecting a high or lower gear when the vehicle 5 decelerates but the engine 3 escalates in speed. Such situation occurs when the vehicle 5 climbs a slope. This scheme thus gives more accurate predictions for preselecting next gear.

The pre-selections of gear enable the double clutch transmission 1 to have lower fuel consumption. The pre-selection reduces chances of abrupt changes of rotation speeds in gearwheels such that momentums of the gearwheels are preserved during gearshifts. The lower fuel consumption facilitates less emission of pollution when the engine 3 uses fossil fuel.

The pre-selections of gear reduce response time when changing between different gears. With the pre-selection, passengers of the vehicle 5 experience less sudden breaks during gearshifts. The vehicle 5 that has the gear pre-selection functions become sporty, but has less discomfort in speeding.

Up-shifting synchronising speed will also be lowered if the pre-selection is performed on a lower vehicle speed. In a synchronising process, synchronisation energy and temperature rise of synchronising parts change depending on a speed differences between synchronising parts (e.g. gearwheel, lay shaft) and a duration of the synchronising process. The synchronisation energy and the temperature rise will be lower if the synchronising process is performed at the lower vehicle speed. The pre-selection function at the lower vehicle speed minimises an amount of the synchronisation energy and the temperature rise.

The pre-selection of gear improves the vehicle's performance on noise, vibration, and harshness (NVH). Since an idler gearwheel of a next gear is pre-selected, less number of parts require locking during an actual engagement step of the next gear. The vehicle 5 with the double-clutch transmission 1 thus experiences reduced noise, vibration and harshness for driving efficiency and comfort. Life span of the double-clutch transmission 1 is extended with lower amount of maintenance required.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for preselecting a gear in a double-clutch transmission comprising:
measuring at least two types of transmission speed of the double-clutch transmission;
evaluating the at least two types of transmission speed;
determining a next gear of the double-clutch transmission); and
preselecting the next gear.

2. The method of claim 1, wherein the at least two types of transmission speed comprise an input speed of the double-clutch transmission.

3. The method of claim 1, wherein the at least two types of transmission speed comprise an acceleration at an output of the double-clutch transmission.

4. The method of claim 2, wherein the at least two types of transmission speed comprise an output speed of the double-clutch transmission.

5. The method of claim 1, wherein the at least two types of transmission speed comprise an acceleration at an input of the double-clutch transmission.

6. The method of claim 1, wherein the determining comprises predicting a higher gear if the double-clutch transmission accelerates

7. The method of claim 1, wherein the determining comprises predicting a lower gear if the double-clutch transmission decelerates.

8. The method of claim 4, wherein the determining further comprises predicting a higher gear if the engine accelerates.

9. The method of claim 4, wherein the determining further comprises predicting a lower gear if the engine decelerates.

10. The method of claim 4, wherein the determining further comprises predicting a higher gear if the input speed of the double-clutch transmission exceeds a speed threshold.

11. The method of claim 4, wherein the determining further comprises predicting a lower gear if the input speed of the double-clutch transmission is lower than the speed threshold.

12. The method of claim 1, wherein the determining further comprises predicting a higher gear if both the double-clutch transmission accelerates and the input speed of the double-clutch transmission increases.

13. The method of claim 1, wherein the determining further comprises predicting a lower gear if both the double-clutch transmission decelerates and the input speed of the double-clutch transmission decreases.

14. A powertrain for preselecting gear, comprising:
a speed sensor mounted on the powertrain;
a transmission control unit connected to the speed sensor;
a double-clutch transmission controlled by the transmission control unit, the double-clutch transmission further comprising:
an inner input shaft;
an outer input shaft enclosing a portion of the inner input shaft;
an inner clutch disc connected to the inner input shaft and an outer clutch disc connected to the outer input shaft;
a first layshaft and a second layshaft spaced apart from the input shafts and arranged in parallel to the input shaft and the output shaft;
a pinion on one of the layshafts for outputting drive torque;
gearwheels arranged on the first layshaft, on the second layshaft, on the inner input shaft and on the outer input shaft;
wherein the gearwheels comprise a first gearwheel train, a second gearwheel train, a third gearwheel train, a fourth gearwheel train and a fifth gearwheel train for providing five sequentially increasing forward gears respectively,
wherein the first gearwheel train comprises a gearwheel first gear on one of the input shafts, meshing with an idler first gear on one of the layshafts;
wherein the third gearwheel train comprises a gearwheel third gear on one of the input shafts, meshing with an idler third gear on one of the layshafts,
wherein the fifth gearwheel train comprising a gearwheel fifth gear on one of the input shafts, meshing with an idler fifth gear on one of the layshafts
wherein the second gearwheel train comprising a gearwheel second gear on the other input shaft, meshing with an idler second gear on the other layshaft
wherein the fourth gearwheel group comprising a gearwheel fourth gear on the other input shaft, meshing with an idler fourth gear on the other layshaft
wherein each gearwheel train comprising a coupling device on one of the layshafts to selectively engage one of the idler gearwheels for providing one of the five gears, and
wherein an output gearwheel on an output shaft for meshing with the pinion,
wherein the transmission control unit is configured to control the double-clutch transmission for preselecting a next gear depending at least two types of transmission speed of the double-clutch transmission.

15. The powertrain of claim 14, further comprising:
an engine that is connected to the input shafts via the two clutch discs; and
a crankshaft of the engine connected to the speed sensor for measuring an engine speed.

16. The powertrain of claim 15, wherein the engine comprises an internal combustion engine.

17. The powertrain of claim 15, wherein the engine comprises an electric motor.

18. The powertrain of claim 15, wherein the engine comprises a hybrid engine.

19. The powertrain of claim 14, wherein the double-clutch transmission further comprises a third layshaft arranged in parallel to the input shafts, the first layshaft and the second layshaft;
a pinion on the third layshaft for outputting the drive torque;
other gearwheels arranged on the third layshaft, the other gearwheels comprising a reverse gearwheel train for providing a reverse gear;
the reverse gear comprising an idler reverse gear on the third layshaft that meshes with the gearwheels on one of the first layshaft and the second layshaft; and
the reverse gearwheel train comprising a third coupling device on the third layshaft to engage the idler reverse gear to the third layshaft for providing the reverse gear.

20. The powertrain of claim 14, wherein the idlers of low gears and idlers of high gears are mounted on separate layshafts.
